(19) United States
(12) Patent Application Publication
(10) Pub. No.: US 2025/0246737 A1
(43) Pub. Date: Jul. 31, 2025

(54) CELL HOLDER TRAYS INCLUDING ELECTRICAL CIRCUITS FOR VEHICLE BATTERY CELLS

(71) Applicant: GM GLOBAL TECHNOLOGY OPERATIONS LLC, Detroit, MI (US)

(72) Inventors: Mohammad Hamza Kirmani, Troy, MI (US); William Thomas Kucinski, Windsor (CA); Anthony Michael Coppola, Rochester Hills, MI (US)

(21) Appl. No.: 18/425,570

(22) Filed: Jan. 29, 2024

(51) Int. Cl. H01M 50/249; H01M 10/653; H01M 50/213; H01M 50/227; H01M 50/244; H01M 50/264; H01M 50/293; H01M 50/51; H01M 50/512; H01M 50/524

(52) U.S. Cl. CPC H01M 50/249; H01M 10/653; H01M 50/213; H01M 50/227; H01M 50/244; H01M 50/264; H01M 50/293; H01M 50/51; H01M 50/512; H01M 50/524; H01M 2220/20

(57) ABSTRACT

An example vehicle battery assembly includes multiple rechargeable battery cells configured to supply power to a drive unit of a vehicle, a cell holder tray mounted within the vehicle, the cell holder tray configured to support the multiple rechargeable battery cells, an upper shear plate, wherein the multiple rechargeable battery cells are between the upper shear plate and the cell holder tray, and an electrical circuit within the cell holder tray, the electrical circuit electrically connected between at least two of the multiple rechargeable battery cells.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to cell holder trays including electrical circuits for vehicle battery cells.

Electric vehicles have electric motors which are at least partially powered via vehicle battery cells. The vehicle battery cells are held together within cell holder trays of the vehicle. Electrical circuits are used to provide electrical connections between the vehicle battery cells.

### SUMMARY

An example vehicle battery assembly includes multiple rechargeable battery cells configured to supply power to a drive unit of a vehicle, a cell holder tray mounted within the vehicle, the cell holder tray configured to support the multiple rechargeable battery cells, an upper shear plate, wherein the multiple rechargeable battery cells are between the upper shear plate and the cell holder tray, and an electrical circuit within the cell holder tray, the electrical circuit electrically connected between at least two of the multiple rechargeable battery cells.

In other features, the electrical circuit includes a dielectric coating configured to electrically insulate the electrical circuit during a thermal runaway condition of the multiple rechargeable battery cells.

In other features, the multiple rechargeable battery cells include at least one of a cylindrical cell, a pouch cell and a prismatic cell. In other features, the electrical circuit is configured to electrically connect the multiple rechargeable battery cells in parallel.

In other features, the electrical circuit is configured to electrically connect the multiple rechargeable battery cells in series. In other features, the multiple rechargeable battery cells are coupled with the cell holder tray via at least one of an adhesive, a snap fit, and a threaded screw.

In other features, the cell holder tray includes multiple threaded features, each of the multiple rechargeable battery cells includes an outer shell having an integrally threaded portion, and each of the multiple rechargeable battery cells is coupled a corresponding one of the multiple threaded features via the integrally threaded portion.

In other features, each of the multiple threaded features includes at least one of a metal, a plastic or a plastic composite. In other features, each of the multiple threaded features comprises a metal insert, and each metal insert is coated with a dielectric coating configured to electrically insulate the electrical circuit during a thermal runaway condition of the multiple rechargeable battery cells.

In other features, the dielectric coating includes at least one of polysilazane, polycarboslilane, boron nitride nanotubes, titanium nitride, chromium carbide, magnesium zirconate, zirconia, titanium, or tungsten.

In other features, the electrical circuit is embedded in material of the cell holder tray via over molding, or the electrical circuit is heat staked with the cell holder tray.

In other features, each of the multiple rechargeable battery cells includes a positive terminal and a negative terminal, and the positive terminal and the negative terminal are located on a same side of the rechargeable battery cell.

In other features, each of the multiple rechargeable battery cells is encapsulated in a polymer potting. In other features, the cell holder tray comprises at least one of a plastic material or filler material.

In other features, the plastic material includes at least one of nylon, polycarbonate, polypropylene, and acrylonitrile butadiene styrene (ABS). In other features, the filler material includes at least one of a flame retardant, a glass fiber, and glass bubbles. In other features, material of the cell holder tray has a V-0 flammability rating.

An example method of manufacturing a vehicle battery assembly includes arranging one or more electrical circuits in a mold of a cell holder tray, embedding the one or more electrical circuits in a plastic material of the cell holder tray via over molding, and coupling multiple rechargeable battery cells with the cell holder tray, wherein, the rechargeable battery cells are configured to supply power to a drive unit of a vehicle, and the electrical circuit is electrically connected between at least two of the multiple rechargeable battery cells.

In other features, the method includes, prior to arranging the one or more electrical circuits in the mold of the cell holder tray, coating the one or more electrical circuits with a dielectric coating configured to electrically insulate the one or more electrical circuits during a thermal runaway condition of the multiple rechargeable battery cells.

An example method of manufacturing a vehicle battery assembly includes arranging one or more electrical circuits on a cell holder tray, coupling the one or more electrical circuits with the cell holder tray via heat staking, and coupling multiple rechargeable battery cells with the cell holder tray, wherein, the rechargeable battery cells are configured to supply power to a drive unit of a vehicle, and the electrical circuit is electrically connected between at least two of the multiple rechargeable battery cells.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example vehicle including a vehicle battery module.

FIG. 2 is an exploded block diagram of example layers and rechargeable battery cells of a vehicle battery assembly.

FIG. 3 is a block diagram of an example vehicle battery assembly including electrical connectors embedded within a cell holder tray.

FIG. 4A is a top view of a cell holder tray including multiple threaded insert features.

FIG. 4B is a side view of the cell holder tray of FIG. 4A, including the multiple threaded insert features.

FIG. 4C is a block diagram of an example battery cell having integral threaded features, for coupling with the threaded insert features of the cell holder tray of FIGS. 4A and 4B.

FIG. 5 is a block diagram of an example vehicle battery assembly including snap fit coupling between the battery cells and the cell holder tray.

FIG. 6 is a flowchart depicting an example process for manufacturing a vehicle battery assembly including one or more electrical circuits embedded in a cell holder tray via over molding.

FIG. 7 is a flowchart depicting an example process for manufacturing a vehicle battery assembly including one or more electrical circuits coupled with a cell holder tray via heat staking.

In the drawings, reference numbers may be reused to identify similar and/or identical elements.

### DETAILED DESCRIPTION

Cell holder trays are used to hold vehicle battery cells together, and may be mounted within a vehicle. The cell holder trays include electrically insulating materials. Electrical connections between vehicle battery cells are electrically isolated, such as via additional layers or plastics and adhesive. Some example embodiments described herein include a multi-functional cell holder tray, where electrical circuits (e.g., busbars, flex circuits, etc.) are located within material of the cell holder tray, which may reduce or eliminate the use of multiple electrical isolation layers and adhesives.

In some examples, each vehicle battery cell may include positive and negative terminals on a same side of the vehicle battery cell, which may facilitate electrically connecting multiple vehicle battery cells in parallel or in series (or a mix of both), via electrical circuits embedded within the cell holder tray. This may reduce or eliminate layers of electrical isolation (e.g., up to three or more layers of electrical isolation that may be needed otherwise), and an amount of adhesives used. Other advantages may include, but are not limited to, increased energy density of the vehicle battery assembly, reduced height and volume of the vehicle battery assembly (e.g., by up to 7.5% or more compared to a vehicle battery assembly where the electrical circuits are not in the cell holder tray), elimination of electrical isolation layers needed between busbars and an upper shear plate, elimination of adhesives needed to connect multiple isolation sheets, elimination of laser welding of busbars to vehicle battery cells, etc.

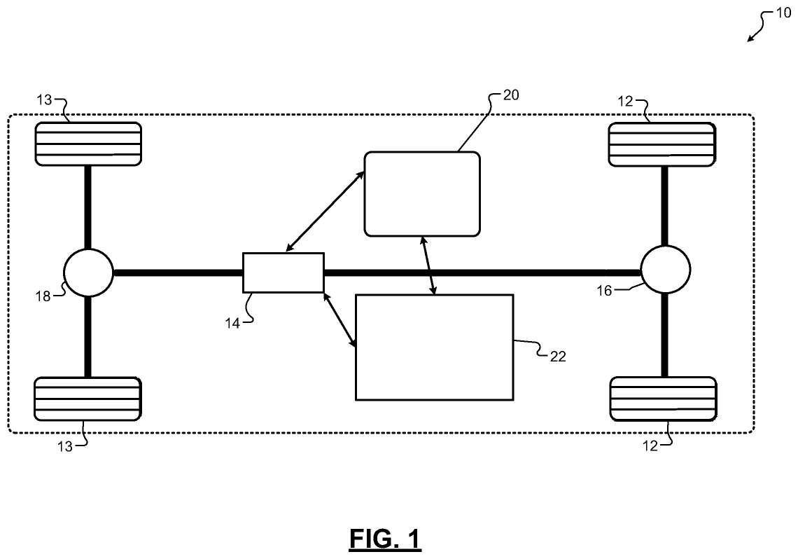

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

For example, the battery cell module 22 may include multiple rechargeable vehicle battery cells configured to supply power to the drive unit 14. As described further below, the multiple battery cells may be supported by a cell tray holder in a vehicle battery assembly, where electrical circuits configured to connect the multiple rechargeable battery cells are located in the cell tray holder.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration pedal, a brake pedal, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, steering wheel position sensors, braking sensors, location sensors such as global positioning system (GPS) antennas, wheel height and/or position sensors, accelerometers, etc.). Some sensors may be configured to monitor current motion of the vehicle, acceleration of the vehicle, braking of the vehicle, current steering direction of the vehicle, current height and/or position of one or more wheels, etc.

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

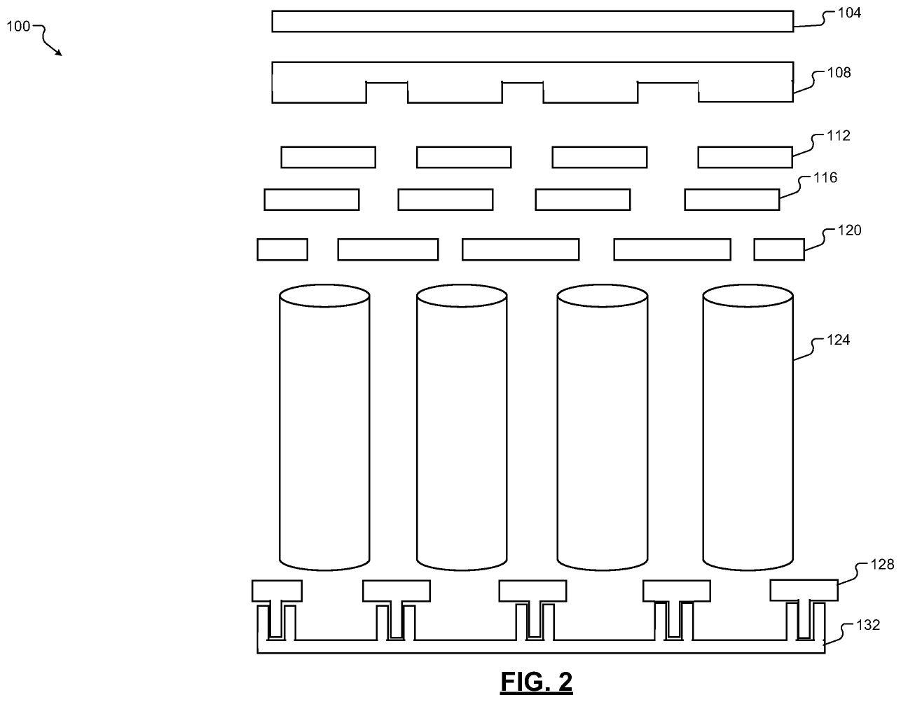

FIG. 2 is an exploded block diagram of example layers and rechargeable battery cells of a vehicle battery assembly 100. As shown in FIG. 2, the vehicle battery assembly 100 includes an upper shear plate 104, which may comprise a metal material.

An interconnection board (ICB) cover 108 is located below the upper shear plate 104, and the ICB cover 108 may include a plastic, polycarbonate material. A flex circuit 112 is located below the ICB cover 108, and collectors 116 are located below the flex circuit 112. The flex circuit 112 and the collectors 116 may comprise metal material.

The ICB frame 120 is located between the collectors 116 and the rechargeable battery cells 124. The ICB frame 120 may be configured to support one or more electrical conductors for electrically connecting the rechargeable battery cells 124 together, and may include a plastic material for holding and routing the electrical circuits.

As shown in FIG. 2, a cell holder tray 128 is positioned below the rechargeable battery cells 124, to support the rechargeable battery cells 124 and hold them together. A thermal runaway protection (TRP) tray 132 is located below the cell holder tray 128.

In some examples, the flex circuit 112 may be configured to monitor the rechargeable battery cells 124, while the collectors 116 carry current to and from the rechargeable battery cells 124. The ICB cover 108 and the ICB frame 120 may form an electrical and structural enclosure for the flex circuit 112 and the collectors 116.

In various implementations, an adhesive may be located between the upper shear plate 104 and the ICB cover 108, and also between the ICB cover 108 and the flex circuit 112. The ICB frame 120 may be mechanically fastened to the vehicle battery assembly at ends of the ICB frame 120. In some examples, the rechargeable battery cells 124 may be laser welded to the collectors 116, to form electrical connections.

In some example embodiments, an optional insulation sheet (e.g., plastic) may be located between the upper shear plate 104 and the ICB cover 108. The components between and including the ICB cover 108 and the ICB frame 120 may be considered as a pack area associated with electrical connections and isolation sheets.

The rechargeable battery cells 124 may be surrounded by a cooling ribbon, may include a cell vent, etc. The cell holder tray 128 may be adhesively bonded to the TRP tray 132. In some examples, the area including the cell holder tray 128 up to the ICB cover 108 may be a potted region (e.g., may be enclosed in a polymer potting).

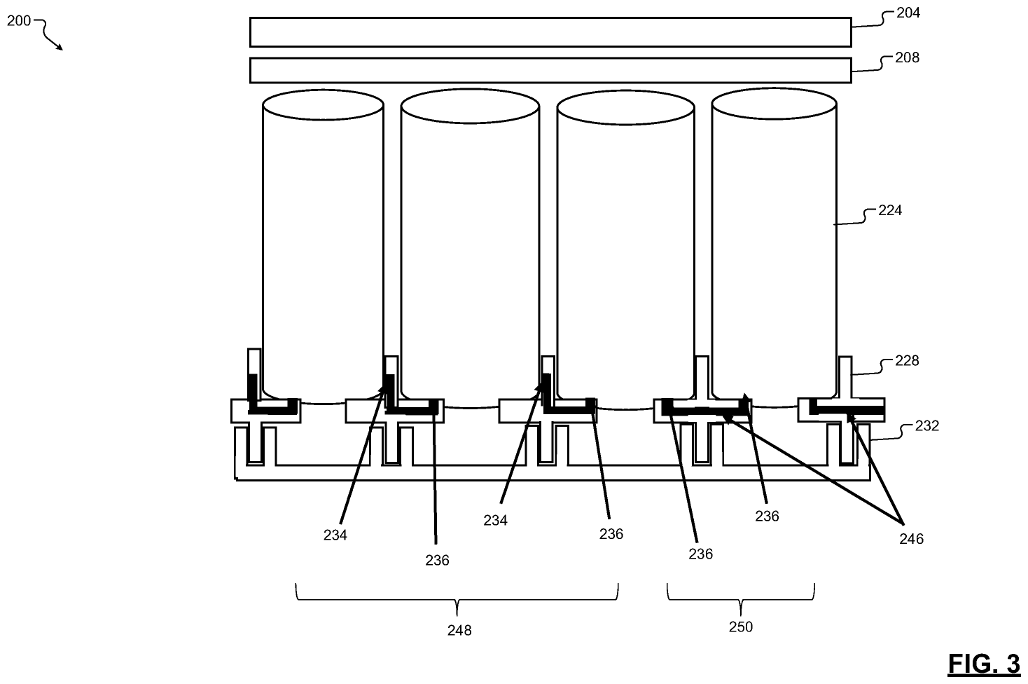

FIG. 3 is a block diagram of an example vehicle battery assembly 200 including electrical connectors embedded within a cell holder tray. As shown in FIG. 3, multiple rechargeable battery cells 224 are located between a cell holder tray 228 and an upper shear plate 204. An optional isolation sheet 208 may be located between the upper shear plate 204 and the rechargeable battery cells 224. The cell holder tray 228 is located on a TRP tray 232.

As shown in FIG. 3, electrical connectors 246 are located in the cell holder tray 228. For example, one or more electrical circuits may be embedded within a material of the cell holder tray 228 (e.g., a plastic material, a filler filled plastic material, etc.). The electrical circuits may be embedded in the cell holder tray 228 via over molding, may be heat staked in the cell holder tray 228, etc.

The electrical connectors 246 may be configured to connect multiple rechargeable battery cells 224 together in a series connection 248, a parallel connection 250, or a combination of both. For example, each rechargeable battery cell 224 may include a first polarity terminal 234 on a side of the rechargeable battery cell 224, and a second polarity terminal 236 on a bottom of the rechargeable battery cell 224. In some example embodiments, the first polarity terminal (e.g., positive terminal) and the second polarity terminal (e.g., negative terminal) may be located on a same side of the rechargeable battery cell.

In the series connection 248, the electrical connectors 246 are electrically connected between the first polarity terminal 234 of one of the rechargeable battery cells 224, and the second polarity terminal 236 of another (e.g., adjacent) one of the rechargeable battery cells 224. In the parallel connection 250, the electrical connectors 246 are electrically connected between the first polarity terminal 234 of one of the rechargeable battery cells 224, and the first polarity terminal 234 of another (e.g., adjacent) one of the rechargeable battery cells 224.

In some example embodiments, the electrical connectors 246 may be coated before being inserted into the cell holder tray 228, such as by a dielectric coating which is configured to remain electrically insulative even under a thermal runaway condition of one or more of the rechargeable battery cells 224. Example coating materials may include, but are not limited to, pre-ceramic polymers (e.g., polysilazane, polycarboslilane), ceramics including boron nitride nanotubes, titanium nitride, chromium carbide, magnesium zirconate, zirconia, titanium, tungsten, combinations thereof, etc.

The rechargeable battery cells 224 may include any suitable cells configured to store power and supply the power to a drive unit such as an electric motor, including cylindrical cells, pouch cells, prismatic cells, etc. The rechargeable battery cells 224 may be arranged in any suitable orientations, with the first polarity terminals 234 and the second polarity terminals 236 facing any face (e.g., six faces) of the vehicle battery assembly enclosure. The rechargeable battery cells 224 may be encapsulated in a polymer potting.

The cell holder tray 228 may be oriented in any suitable direction, such as a top, bottom, or side of the vehicle battery assembly. In some examples, the cell holder tray 228 may include a plastic material, a filler filled plastic material, etc. The plastic material may include, for example, nylon, polycarbonate, polypropylene, acrylonitrile butadiene styrene (ABS), etc. The filler may include a flame retardant, glass fiber, glass bubbles, etc. In some examples, the cell holder tray 228 may have a V-0 flammability rating (e.g., where burning stops within ten seconds after two applications of ten seconds each of a vertical flame to a test bar, where no flaming drips are allowed).

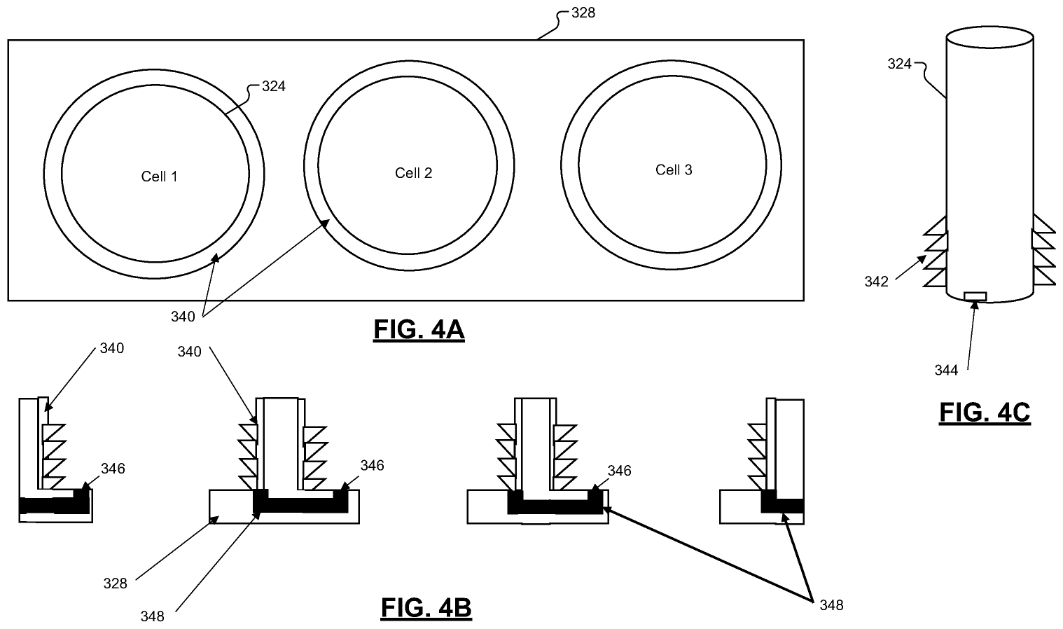

FIG. 4A is a top view of a cell holder tray 328 including multiple threaded insert features 340. Each threaded insert feature 340 may correspond to a different rechargeable battery cell 324. As shown in FIG. 4A, each rechargeable battery cell 324 may be cylindrical, to correspond to a circular shape of a threaded insert feature 340.

FIG. 4B is a side view of the cell holder tray 328 of FIG. 4A, including the multiple threaded insert features 340. As shown in FIG. 4B, electrical connectors 348 are located in the cell holder tray 328. The electrical connectors 348 may be connected to the threaded insert features 340 at a first end, and include a second end 346 for connection with a first polarity terminal 344 of the rechargeable battery cell 324.

For example, FIG. 4C is a block diagram of an example rechargeable battery cell 324 having integral threaded features 342, for coupling with the threaded insert features 340 of the cell holder tray 328 of FIGS. 4A and 4B. The integral threaded features 342 may be on an outer shell of the rechargeable battery cell 324 for treaded connection with the threaded insert features 340 of the cell holder tray 328.

Therefore, the integral threaded features 342 may join the rechargeable battery cell 324 with the cell holder tray 328, and facilitate connection of the rechargeable battery cell 324 with the electrical connectors 348 located in the cell holder tray 328. For example, the integral threaded features 342 may define a second polarity terminal of the rechargeable battery cell 324 for connection with an end of the electrical connectors 348 in contact with the threaded insert features 340 of the cell holder tray 328, and the rechargeable battery cell 324 may include a first polarity terminal 344 for connection with the second end 346 of the electrical connectors 348 when the rechargeable battery cell 324 is joined with the cell holder tray 328.

The threaded insert features 340, and the integral threaded features 342, may include metal, plastic, plastic composite, etc. In some examples, the threaded insert features 340 and the integral threaded features 342 may be coated with a high temperature resistant dielectric coating which is configured to remain electrically insulative even under a thermal runaway condition of one or more of the rechargeable battery cells 324. Example coating materials may include, but are not limited to, pre-ceramic polymers (e.g., polysilazane, polycarboslilane), ceramics including boron nitride nanotubes, titanium nitride, chromium carbide, magnesium zirconate, zirconia, titanium, tungsten, combinations thereof, etc.

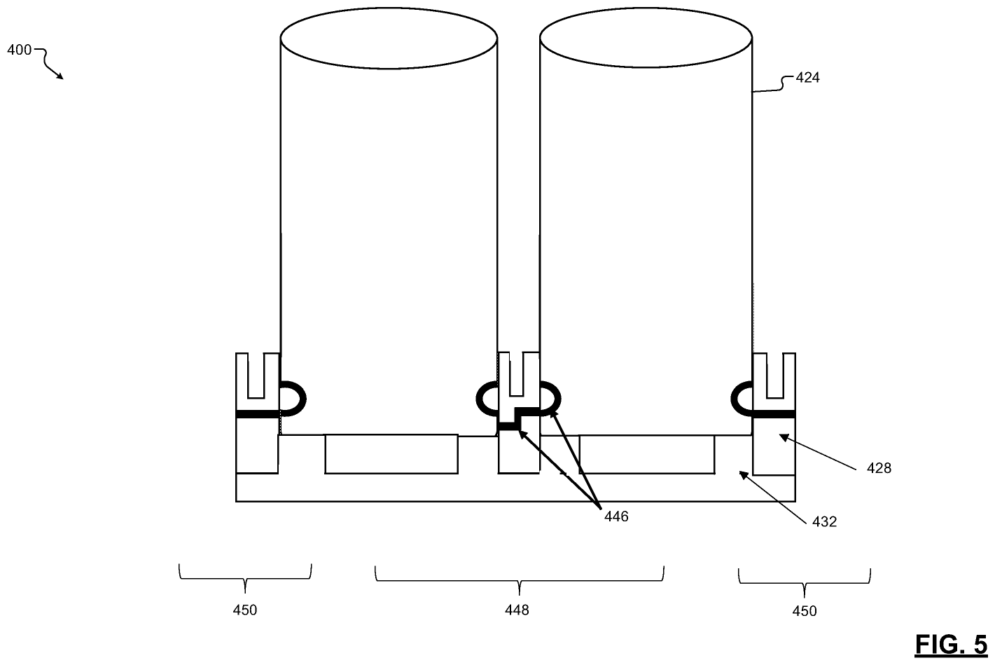

FIG. 5 is a block diagram of an example vehicle battery assembly 400 including snap fit coupling between the rechargeable battery cells 424 and the cell holder tray 428. As shown in FIG. 5, the cell holder tray 428 is located on a TRP tray 432, and electrical connectors 446 are located in the cell holder tray 428.

For example, the electrical connectors 446 between the rechargeable battery cells 424 may be embedded in the cell holder tray 428 with different cell to cell tray interfaces. The cell holder tray 428 may include cell locating and mechanical interlocking features, which may be non-threaded, snap fit, etc. The electrical connectors 446 may be adapted to fit around curves of snap fit protrusions, etc. In some example embodiments, adhesive may be used to facilitate coupling of the rechargeable battery cells 424 to the cell holder tray 428.

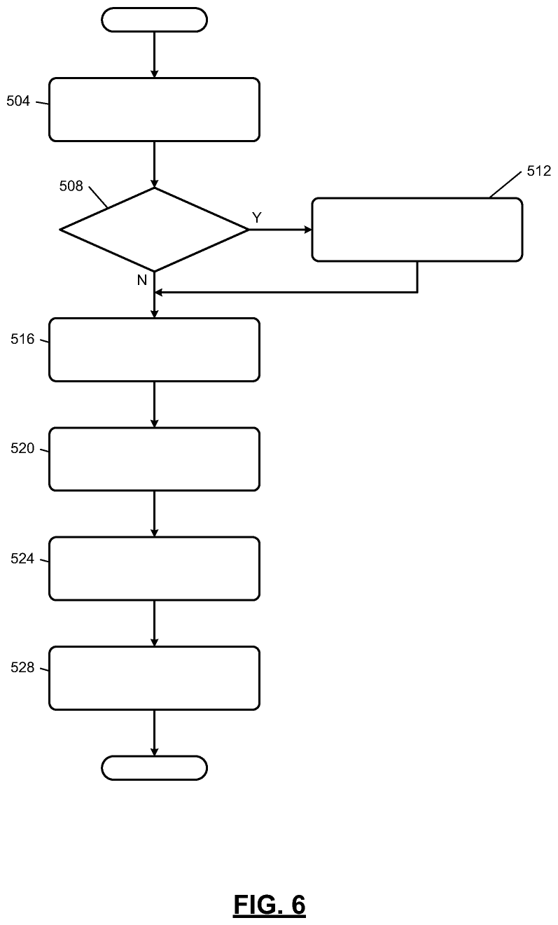

FIG. 6 is a flowchart depicting an example process for manufacturing a vehicle battery assembly including one or more electrical circuits embedded in a cell holder tray via over molding. At 504, the process begins by obtaining electrical connectors for connecting the battery cells.

At 508, the process includes determining whether a dielectric coating will be used for the electrical connectors. If so, the process proceeds to 512 to coat the electrical connectors with a high temperature resistant dielectric coating. After coating the electrical connectors, or if a dielectric coating is not used, the electrical connectors are assembled into a mold orientation (e.g., a cell holder tray mold) at 516.

The process continues at 520 to mold a carrier frame over the assembly including the electrical connectors. For example, a plastic material of the cell holder tray may fill the mold and surround the electrical connectors. The carrier assembly is then assembled to the battery cells at 524, and the electrical connectors are connected to the battery cells at 528 (e.g., via a weld, screw threads, a snap fit, etc.).

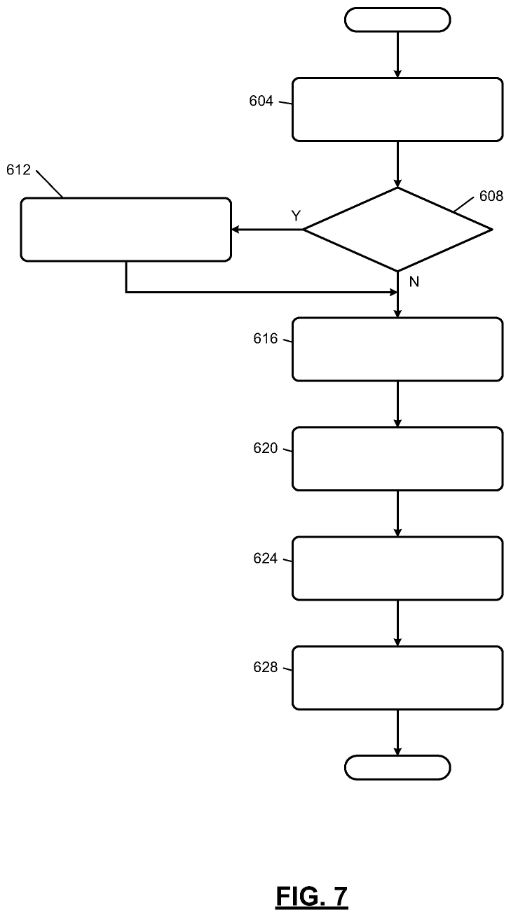

FIG. 7 is a flowchart depicting an example process for manufacturing a vehicle battery assembly including one or more electrical circuits coupled with a cell holder tray via heat staking. At 604, the process begins by obtaining electrical connectors for connecting the battery cells.

At 608, the process includes determining whether a dielectric coating will be used for the electrical connectors. If so, the process proceeds to 612 to coat the electrical connectors with a high temperature resistant dielectric coating. After coating the electrical connectors, or if a dielectric coating is not used, the electrical connectors are assembled onto a cell carrier (e.g., a cell holder tray) at 616.

The process continues at 620 to heat stake the electrical connectors to the cell carrier. For example, the heat staking may include use of local heating and cooling to raise the temperature of plastic components (e.g., plastic of the cell holder tray) and allow plastic reforming to be carried out, where the plastic reforming joins the electrical connectors to the cell holder tray (e.g., by sinking into melted plastic of the cell holder tray). The carrier assembly is then assembled to the battery cells at 624, and the electrical connectors are connected to the battery cells at 628 (e.g., via a weld, screw threads, a snap fit, etc.).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle battery assembly comprising:
multiple rechargeable battery cells configured to supply power to a drive unit of a vehicle;
a cell holder tray mounted within the vehicle, the cell holder tray configured to support the multiple rechargeable battery cells;
an upper shear plate, wherein the multiple rechargeable battery cells are between the upper shear plate and the cell holder tray; and
an electrical circuit within the cell holder tray, the electrical circuit electrically connected between at least two of the multiple rechargeable battery cells.

2. The vehicle battery assembly of claim 1, wherein the electrical circuit includes a dielectric coating configured to electrically insulate the electrical circuit during a thermal runaway condition of the multiple rechargeable battery cells.

3. The vehicle battery assembly of claim 1, wherein the multiple rechargeable battery cells include at least one of a cylindrical cell, a pouch cell and a prismatic cell.

4. The vehicle battery assembly of claim 1, wherein the electrical circuit is configured to electrically connect the multiple rechargeable battery cells in parallel.

5. The vehicle battery assembly of claim 1, wherein the electrical circuit is configured to electrically connect the multiple rechargeable battery cells in series.

6. The vehicle battery assembly of claim 1, wherein the multiple rechargeable battery cells are coupled with the cell holder tray via at least one of an adhesive, a snap fit, and a threaded screw.

7. The vehicle battery assembly of claim 1, wherein:
the cell holder tray includes multiple threaded features;
each of the multiple rechargeable battery cells includes an outer shell having an integrally threaded portion; and
each of the multiple rechargeable battery cells is coupled a corresponding one of the multiple threaded features via the integrally threaded portion.

8. The vehicle battery assembly of claim 7, wherein each of the multiple threaded features includes at least one of a metal, a plastic or a plastic composite.

9. The vehicle battery assembly of claim 8, wherein:
each of the multiple threaded features comprises a metal insert; and
each metal insert is coated with a dielectric coating configured to electrically insulate the electrical circuit during a thermal runaway condition of the multiple rechargeable battery cells.

10. The vehicle battery assembly of claim 9, wherein the dielectric coating includes at least one of polysilazane, polycarboslilane, boron nitride nanotubes, titanium nitride, chromium carbide, magnesium zirconate, zirconia, titanium, or tungsten.

11. The vehicle battery assembly of claim 1, wherein the electrical circuit is embedded in material of the cell holder tray via over molding, or the electrical circuit is heat staked with the cell holder tray.

12. The vehicle battery assembly of claim 1, wherein:
each of the multiple rechargeable battery cells includes a positive terminal and a negative terminal; and
the positive terminal and the negative terminal are located on a same side of the rechargeable battery cell.

13. The vehicle battery assembly of claim 1, wherein each of the multiple rechargeable battery cells is encapsulated in a polymer potting.

14. The vehicle battery assembly of claim 1, wherein the cell holder tray comprises at least one of a plastic material or filler material.

15. The vehicle battery assembly of claim 14, wherein the plastic material includes at least one of nylon, polycarbonate, polypropylene, and acrylonitrile butadiene styrene (ABS).

16. The vehicle battery assembly of claim 14, wherein the filler material includes at least one of a flame retardant, a glass fiber, and glass bubbles.

17. The vehicle battery assembly of claim 14, wherein material of the cell holder tray has a V-0 flammability rating.

18. A method of manufacturing a vehicle battery assembly, the method comprising:
arranging one or more electrical circuits in a mold of a cell holder tray;
embedding the one or more electrical circuits in a plastic material of the cell holder tray via over molding; and
coupling multiple rechargeable battery cells with the cell holder tray, wherein,
the rechargeable battery cells are configured to supply power to a drive unit of a vehicle, and
the electrical circuit is electrically connected between at least two of the multiple rechargeable battery cells.

19. The method of claim 18, further comprising, prior to arranging the one or more electrical circuits in the mold of the cell holder tray, coating the one or more electrical circuits with a dielectric coating configured to electrically insulate the one or more electrical circuits during a thermal runaway condition of the multiple rechargeable battery cells.

20. A method of manufacturing a vehicle battery assembly, the method comprising:
arranging one or more electrical circuits on a cell holder tray;
coupling the one or more electrical circuits with the cell holder tray via heat staking; and
coupling multiple rechargeable battery cells with the cell holder tray, wherein,
the rechargeable battery cells are configured to supply power to a drive unit of a vehicle, and
the electrical circuit is electrically connected between at least two of the multiple rechargeable battery cells.
